(19) United States
(12) Patent Application Publication
(10) Pub. No.: US 2026/0169720 A1
(43) Pub. Date: Jun. 18, 2026

(54) SOFTWARE MANAGEMENT

(71) Applicant: SPECIFIC-GROUP MD USA LLC, Seattle, WA (US)

(72) Inventors: Josef Bartholomäus SCHIEFER, Bellevue, WA (US); Marcus-Emanuel BRANDSTETTER, Vienna (AT); Aliaksandr KHARUZHY, Warsaw (PL)

(21) Appl. No.: 18/980,878

(22) Filed: Dec. 13, 2024

(51) Int. Cl. G06F 8/65; G06F 16/3329; G06F 16/901; H04L 51/02

(52) U.S. Cl. CPC G06F 8/65; G06F 16/33295; G06F 16/9024; H04L 51/02

(57) ABSTRACT

Computer-implemented methods for responding to a query about a software application comprise receiving a query at a user interface (UI), and then accessing a knowledge graph from memory. The knowledge graph comprises nodes linked by edges, and is generated using data related to the application. Each node stores data related to an artifact of the application, and each edge represents a relationship between artifacts of the application. The query is divided into subqueries. Each subquery is dispatched to an agent to retrieve information from the knowledge graph and generate output corresponding to the subquery using a generative machine learning model. The specialized agents are specialized in a programming language, specialized in a database system, and/or specialized in security analysis. A query response is generated by combining subquery outputs. The query response is either presented in a UI or an action is triggered to update the application according to the response.

### TECHNICAL FIELD

The present invention relates to development and management of software applications.

### BACKGROUND

Software applications comprise a program or group of programs which perform specific tasks. Software applications such as legacy applications are often complex and developed over a period of time. Expertise in a software application is frequently confined to few individuals leading to knowledge silos. Documentation for an application is typically produced manually and constraints on developer time and resources mean that documentation can be brief and out of date.

The embodiments described below are provided by way of example only and are not limiting of implementations which solve any or all of the disadvantages of known methods for processing software application data.

### SUMMARY

This summary is provided to present a selection of concepts disclosed herein in a simplified form, which are described in more detail below. This summary is not intended to identify key features or essential features of the claimed subject matter nor is it intended to be used to limit the scope of the claimed subject matter.

Computer-implemented methods for responding to a query about a software application comprise receiving a query at a user interface, and then accessing a knowledge graph from memory. The knowledge graph comprises a plurality of nodes linked by edges, and is generated using data related to the software application. Each node stores data related to an artifact of the software application, and each edge represents a relationship between artifacts of the software application. Using a processor, the query is divided into a plurality of subqueries. Each subquery is dispatched to an agent of a plurality of specialized agents to retrieve information from the knowledge graph and generate output corresponding to the subquery using a generative machine learning model. The plurality of specialized agents comprises at least one of: an agent specialized in a programming language, an agent specialized in a database system, and an agent specialized in security analysis. Using the processor, a query response is generated by combining output for each of the subqueries. In response to the query response being generated, the query response is either presented in a user interface or an action is triggered to automatically update the software application according to the query response.

### DESCRIPTION OF THE DRAWINGS

The present description will be better understood from the following detailed description read in light of the accompanying drawings, wherein:

FIG. 1 is a schematic diagram depicting processing a query about a software application;

FIG. 2 is a schematic diagram showing an example knowledge graph 200;

FIG. 3 is a schematic diagram showing processing of a query using an agentic retrieval-augmented generation system;

FIG. 4 shows an example explorer user interface;

FIG. 5 shows an example advisor module interface;

FIG. 6 shows an example chatbot interface;

FIG. 7 is a flow diagram of a method for responding to a query about a software application; and

FIG. 8 illustrates an exemplary computing-based device.

### DETAILED DESCRIPTION

The following description is presented in connection with the appended drawings and is intended as a description of the present examples to enable a person skilled in the art to make and use the invention. The description is not intended to represent the only forms in which the present examples are constructed or utilized. The present invention is not limited to the embodiments described herein and various modifications to the disclosed embodiments will be apparent to those skilled in the art.

Software applications comprise a program or group of programs which perform specific tasks. Software applications such as legacy applications are often complex and developed over a period of time. As a result of extended development times, software applications may contain source code which is incompatible with modern computer systems such as cloud-based environments, or code may incorporate outdated coding practices, inefficiencies and non-compliant code structures. Other problems associated with software applications include accumulation of technical debt by quick fixes and ad-hoc solutions, and introduction of errors when modifying code. Technical debt refers to a future cost of reworking source code that is expected due to having prioritized expedience over long-term design. Errors in code leads to efficiency problems as well as wasted computing resources. Security vulnerabilities may also be present in software application.

Expertise in a software application is frequently confined to few individuals leading to knowledge silos. Documentation for an application (which may comprise written materials that describe architecture, functionality, and/or usage instructions) is typically produced manually and constraints on developer time and resources mean that documentation can be brief and out of date. For example, outdated documentation makes software applications difficult to use. Complex architecture and code dependencies make applications challenging to understand without suitable documentation. Even when documentation is produced, it is difficult to anticipate how future developers will use or extend the application. This mean that the existing documentation is not helpful to future developers. Also, changing teams of developers working on an application mean that developers have diverse skill sets and perspectives.

Overall this means that a software application may be difficult to understand, difficult to maintain in terms of finding and fixing problems with the code base, and difficult to develop. Errors, inefficiencies, vulnerabilities and bugs can be introduced and difficult to fix resulting in wasted time, wasted computational resources and security breaches. If existing legacy software is able to be enhanced and/or extended then the legacy application may be rejuvenated and adapted to meet modern requirements.

Commonly used methods of producing documentation for a software application include manual documentation by developers. However, developers under time and resource constraints often produce low quantities of unreliable documentation. Furthermore, each time a change is made to the code base the documentation becomes outdated requiring continued human effort and time. Code comments and inline documentation may reduce some of the burden on developers, but these comments are often brief, lacking in detail, and/or neglected over time.

Static code analysis tools are also used to analyze code for errors, security vulnerabilities, and compliance with coding standards. These tools have a limited scope in that they are focused on syntax and potential errors. They also lack contextual understanding.

Disclosed herein are various methods and systems for responding to a query about a software application, for example a complex application which may be a legacy application. The query is received at a user interface. A query response is generated which is either presented in a user interface, or triggers an action to automatically update the software application according to the query response. Displaying the query response in a user interface means that a user, for example a software developer or IT professional, can see the query response or hear the response in the case of an audio user interface. The user for example receives an answer to a question about the software code base. In other examples, the query response triggers an action to automatically update the software application according to the query response. For example, if the query response is portion of source code which fixes a security vulnerability or bug, the action may be to automatically include the portion of source code in the software application. In other examples, documentation may be generated or updated according to the query response which may include a portion of documentation or an update to documentation.

Generating query responses and either presenting the query response in a user interface or automatically updating the software application allows users (e.g. developers and IT professionals) to understand, manage and modernize software applications. Users working with a software application can view answers to questions about the software application, helping them to understand the software application and continue to develop the application in an efficient manner which results in a software application which is efficient, accurate, and secure. Furthermore, an action may be triggered to automatically update the software application. The action could be a code modification to improve source code of the application for example making the code more efficient in terms of required memory and processor resources, more secure and/or more suited to modern architecture. Further examples of code modifications include but are not limited to: a database, a database access logic change; a change to configurability of the software application; an additional function of the software application, an error correction; a performance improvement; a security update; a technology integration; an operational improvement; a technical debt reduction; a testing enhancement.

As described further below, the query may be received from a user via a chatbot interface, via an interactive graphical user interface which displays components of the software application (which may be the interface of an “explorer” module), and/or from an “advisor” module which provides update recommendations for the software application. A chatbot interface provides a user-friendly means for a user to interact with a computer system. The explorer module displays components of the software application, which a user may view. The user for example requests information about one or more components. An advisor module provides update recommendations and is used by a user wishing to improve a software application. The advisor module for example identifies problems or vulnerabilities in the software application and suggests improvements or update recommendations.

As described herein, a query response is generated using a knowledge graph stored. In various scenarios the knowledge graph is stored in memory and in further scenarios the knowledge graph is stored persistently in a database such as Neo4j. The knowledge graph comprises a plurality of nodes linked by edges and is generated using data related to the software application. Each node stores data related to an artifact of the software application and each edge represents a relationship between artifacts of the software application. An artifact of the software application, also called a software artifact, is a concept which defines the structure or knowledge of program, source code or database. An artifact represents valuable information about an item or element within the software. In various examples an artifact is an item produced during the software development process. Examples of software artifacts include but are not limited to: Java classes, methods, routines, variables, code repository artifacts (e.g. code files, version histories, commit messages), documents, content, documentation, test cases, domain objects, relationships between any of the former, or any other suitable artifact. In a scenario, edges of the knowledge graph may be treated as artifacts. In some examples, a knowledge graph is accessed from memory for example from a database such as Neo4j, the knowledge graph comprising a plurality of nodes representing software artifacts and edges representing dependencies between these artifacts, the knowledge graph generated using data related to the software application's source code, documentation, and runtime metrics. A knowledge graph allows for efficient representation and querying of relationships between software artifacts. In order to generate a query response, the query is divided into subqueries. This allows different parts of the query to be addressed separately, leading to a more accurate query response. Each subquery is dispatched to an agent of a plurality of specialized agents. A specialized agent may be specialized in the sense that it is assigned to a particular programming language or a particular database system. The plurality of specialized agents comprises at least one of: an agent specialized in a programming language, an agent specialized in a database system, an agent specialized in security analysis. Using a specialized agent means that each agent can produce output with a high accuracy. Each specialized agent queries the knowledge graph and generates output using a generative machine learning model such as a large language model. The combination of the generative machine learning model and information retrieved from the knowledge graph results in accurate output from the specialized agent. This is because information from the knowledge graph allows connections between artifacts to be used to generate the output. In some examples, dispatching each subquery to a specialized agent selected from agents specialized in programming languages, database systems, or security analysis, is done to retrieve information from the knowledge graph and generate output corresponding to the subquery using a generative machine learning model.

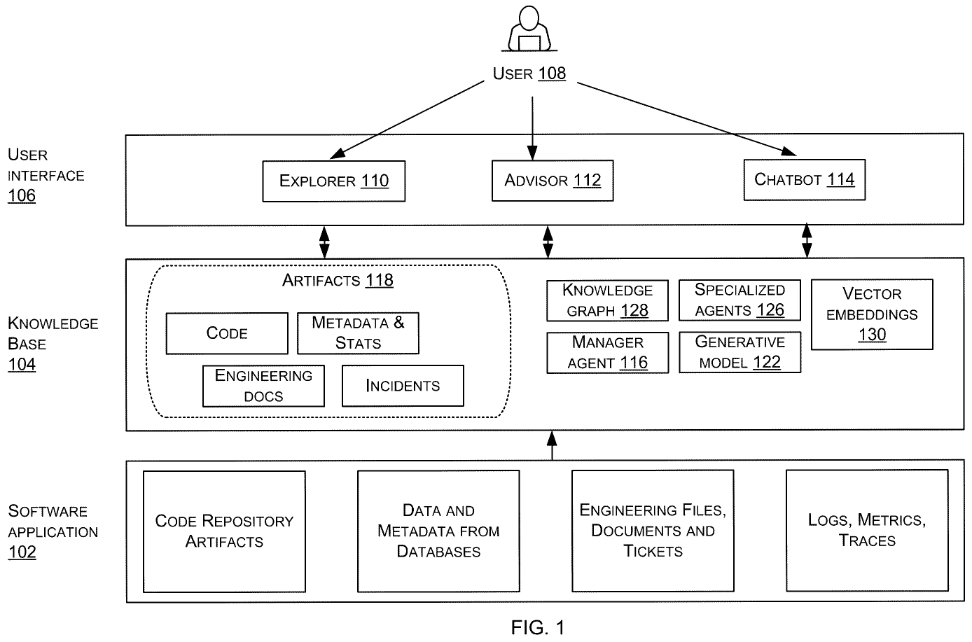

FIG. 1 is a schematic diagram depicting processing a query about a software application. Software application 102 comprises multiple components comprising source code repositories, databases, logs, engineering files and other components. As shown in FIG. 1, the software application includes components which may be heterogeneous. The components may be code repository artifacts (e.g. code files, version histories, commit messages), and/or data and metadata from databases used by the source code (e.g. schemas, tables, stored procedures, queries). Other components are documentation such as technical manuals, design documents, requirement specifications, as well as engineering files, documents and tickets (e.g. bug reports, feature requests, support tickets) that were created for building or operating the application. Logs such as application logs, performances logs, and error logs, operational metrics and traces are also included. These components constitute information about the software application and this information is used to respond to a query. Information about components included in the software application include structured and unstructured data and in various scenarios both data types are used to respond to a query and included in a knowledge graph. In various examples, knowledge base 104 may monitor data sources for changes and performs incremental synchronization which keeps the knowledge base updated.

Information about the software application is ingested into a knowledge base 104, which organizes and interprets the data. This allows a query response to be generated. Knowledge base 104 is graph-based and leverages a knowledge graph 128. As described in more detail below, the knowledge graph 128 efficiently represents and manages code dependencies and relationships between different software artifacts 118. A plurality of specialized agents 126 are used to query the knowledge graph and generate output corresponding to a subquery. Along with generative model 122, the specialized agents 126 form an agentic retrieval-augmented generation (RAG) system. One or more specialized agents of specialized agents 126 may be assigned to different programming languages used in the source code. For example, a specialized agent may be assigned to C, C++, Java, SQL. The specialized agents may be configured to process call graphs and code dependencies for source-code analysis. Furthermore, one or more of the specialized agents may be assigned to different database systems such as PostgreSQL, MySQL, Redis or Cassandra. To generate a query response, a query is divided into a plurality of subqueries each of which is dispatched to a specialized agent. In various scenarios this is performed by a manager agent 116.

Once each specialized agent receives a subquery from manager agent 116, the specialized agent generates output. Output is generated by retrieving information from knowledge graph 128 and inputting the retrieved information to generative model 122. Output from each specialized agent is combined, for example by manager agent 116 to generate a query response.

A user 108 interacts with a user interface 106. The user may interact with a chatbot 114, an advisor 112, and/or an explorer 110. Chatbot 114 is described in more detail below and may be a natural language chatbot. In various examples, a query may be received from a user such as user 108 via chatbot 114. For example, the user enters a query into chatbot 144. The user query is processed using knowledge base 104, knowledge graph 128, generative model 122 and specialized agents 126 in order to generate a query response. The query response may be presented to the user via chatbot 114.

Advisor 112 may be a computer-implemented module which can automatically detect in source code, for example technical debt, anomalies, outdated code practices, errors, inefficiencies, non-compliant code structures, or security vulnerabilities. Advisor 112 may furthermore provide actionable recommendations for example code modifications.

Explorer 110 may be a computer-implemented module which enables user 108 to navigate through documentation and/or visualize architecture, components or interdependencies in the software application. A graphical user interface may provide interactive diagrams, allowing user 108 to select to view details regarding specific modules or code snippets. In various examples, a query is received via an interactive graphical user interface of the explorer module which displays components of the software application.

The methods described above result in generation of an accurate query response in an efficient way. Accuracy of the query response is improved by using a knowledge graph to retrieve information relating to the software application. In various scenarios, the knowledge graph is generated using multiple varied data sources about the software application. The data sources may provide heterogeneous data which is included in the knowledge graph and can therefore be retrieved for use in generating a query response. Data sources in various examples include both structured and unstructured data and both data types may be included in the knowledge graph. Because the knowledge graph includes edges representing relationships between software artifacts which can be traversed, relevant information can be quickly and accurately extracted from the knowledge graph. Also, accuracy of the query response is improved by dividing the query into a plurality of subqueries. This means that output corresponding to each subquery can be generated by a specialized agent and is therefore more accurate than processing a query including multiple parts all at once. Output from the subqueries is combined so that each of the specialized agents is leveraged to produce the query response.

Once a query response is generated, the query response may be displayed at a user interface, such as a chatbot interface, an interface of the explorer module or an interface of the advisor module. Displaying a query response in a user interface allows the user to view the query response and receive user-friendly information relating to the software application. Using the information, the user can maintain and develop the software application in a way which results in efficiency, security, accuracy and a reduction in errors and bugs. Alternatively or additionally an action is triggered to automatically update the software application according to the query response. This results in efficient improvement of the software application, wherein an update to the software application is automatically applied without human input.

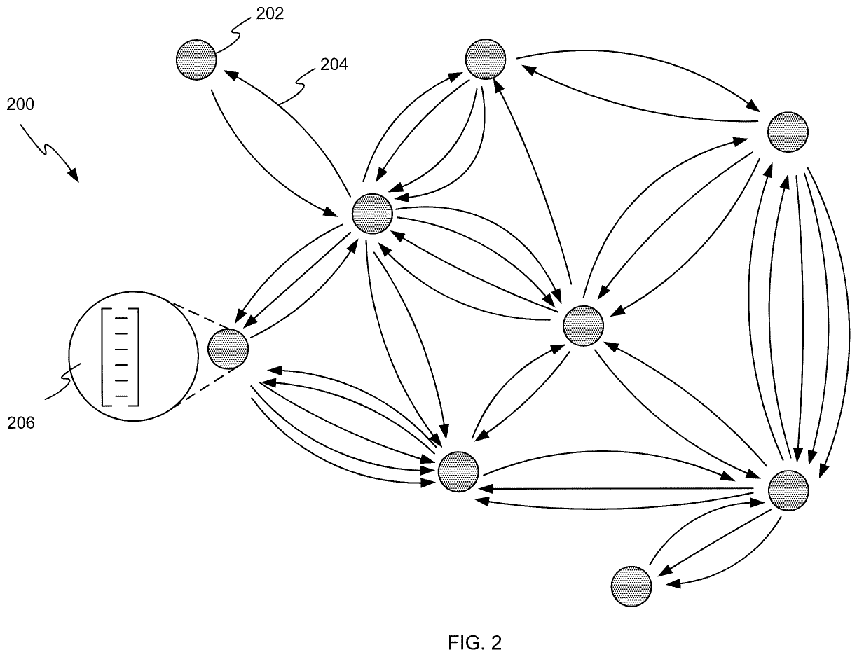

FIG. 2 is a schematic diagram showing an example knowledge graph 200. Knowledge graph 200 is an example of knowledge graph 128 in FIG. 1. Knowledge graph 200 includes nodes such as node 202 and edges such as 204. Edges link the plurality of nodes in the knowledge graph. Knowledge graph 200 is generated for example using data sources from the software application described with reference to FIG. 1 e.g. code repository artifacts, documentation and data and metadata from databases. In various examples, each node 202 stores data related to an artifact of the software application and each edge 204 represents a relationship between artifacts of the software application. For example a node represents an entity such as any one of: a project, an employee, a customer, a remark, a file, a module, a database table, an error message, or any other suitable artifact. An example relationship between two nodes may be that an employee is part of a project. Information about an entity represented by a node is annotated to the node in some cases, or a reference annotated to the node refers to a storage location where the information is stored.

Some example knowledge graphs are generated by a process which involves converting software code, configuration, or other structured files into a graph representation with embeddings. In various scenarios, a set of facts are associated with the graph's nodes and edges. A fact, also called a triple, is represented as text. A triple includes a subject, a predicate, and an object. The predicate describes the relationship between two nodes, the subject and the object. If a node is used in more than one triple then the node may be both a subject and an object simultaneously. In various scenarios, the process for generating example knowledge graphs uses traditional parsing techniques and/or machine learning models such as large language models which may be combined with categorization, normalization and duplicate checks.

In some scenarios, each node 202 stores a vector embedding of the artifact stored at, or referenced by the node. An example vector embedding is depicted at 206 in FIG. 2. For example, a node stores data related to a code snippet, and the node further stores a vector embedding of the code snippet. In various examples, embeddings are computed for facts, combined facts, and graph node structures (expressed as text) along with their combined facts. A vector embedding may be generated for example using an encoder model. The encoder model may be a neural network or any other suitable type of model. A non-exhaustive list of examples of encoder models which may be used is CLIP, BERT. Where two or more different encoder models are used, a mapping component maps the outputs of the different encoder models to a common embedding space.

Information is retrieved from knowledge graph 200. For example a specialized agent retrieves information from the knowledge graph after receiving a subquery which may be from a manager agent. Information from knowledge graph 200 is retrieved by following edges such as 204 in the graph starting from a starting node. Each edge represents a relationship between the two nodes that the edge connects. Therefore, by retrieved artifacts in the nodes connected to the starting node, relevant information is retrieved.

In some examples, information is retrieved from the knowledge graph using a vector search in vector space as well as by travelling along edges of the graph to find neighboring nodes of a starting node. An example of a vector search to identify a node in the knowledge graph is based on distance between a vector embedding of an artifact associated with the node and an input vector embedding. For example, the input embedding is a vector embedding of the query, or a subquery dispatched to one of the specialized agents. The input embedding may be a generated using a keyword, a text snippet, sentence and/or a portion of code. The vector search comprises finding vector embeddings which are near to the input embedding in vector space such as by using a cosine similarity metric. In some examples, the vector search finds a vector embedding which is the shortest distance from the input embedding in vector space. The returned vectors correspond to artifacts which in turn correspond to nodes in the knowledge graph. Thus, a vector search is used to find one or more nodes in the knowledge graph.

In scenarios, a node is identified using the vector search which is a starting node. This is done by encoding a query into a vector and then searching the graph for the node which has a vector closest in embedding space to the encoded query. From the starting node, the knowledge graph is traversed along its edges to find neighboring nodes of the starting node. Information about the starting node and related nodes is thereby retrieved. In further scenarios, there are multiple starting nodes identified using the vector search (such as by finding the top k nodes which are closest in embedding space to the encoded query). Starting from each starting node, the knowledge graph is traversed. The search returns the annotations of several starting nodes together with graph neighbors of each starting node. In some cases one hop neighbors are returned which are nodes that are directly connected to the starting node(s). In some cases one and two hop neighbors are returned which are first nodes that are directly connected to the starting node(s) and second nodes which are directly connected to the first nodes.

Using a vector search and travelling along edges of the graph to find neighboring nodes to retrieve information means that information retrieval is more accurate and efficient because advantage of both the knowledge graph and the vector search are leveraged. The knowledge graph allows relationships between software artifacts to be taken into consideration during information retrieval. Using vector search means that artifacts which are similar to an input query can be found in an accurate and efficient way.

As mentioned above, information is retrieved from the knowledge graph by a specialized agent. The specialized agent receives a subquery and retrieves information from the knowledge graph, including artifacts such as documents and content, in response to receiving the subquery.

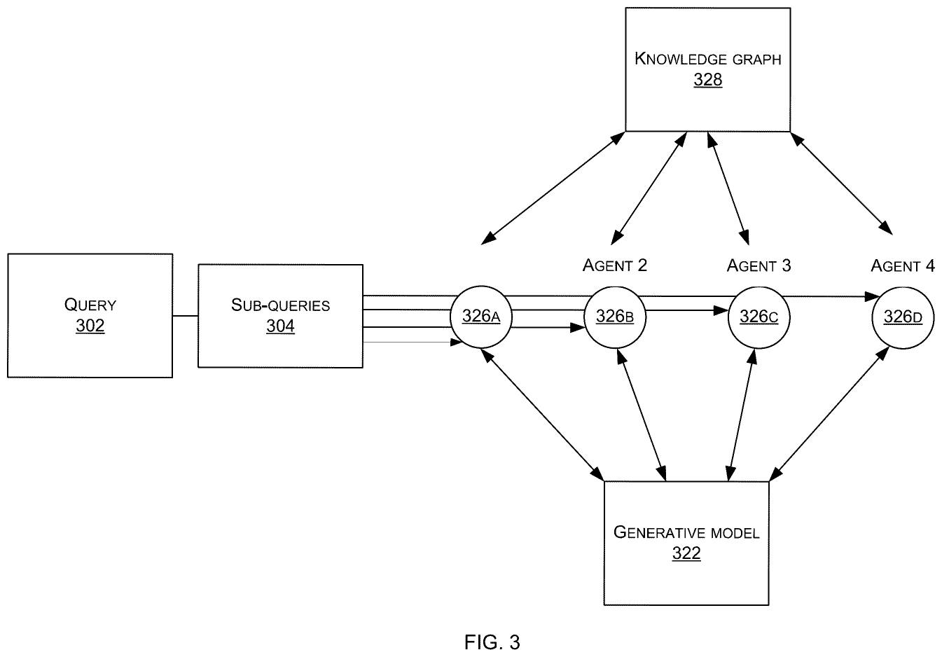

FIG. 3 is a schematic diagram showing processing of a query using an agentic retrieval-augmented generation system. The agentic retrieval-augmented generation system comprises a generative machine learning model such as a large language model and a plurality of specialized agents. A query 302 is received and divided into subqueries 304. For example, the query is divided into subqueries using rules or by asking a generative model 322 to divide the query into subqueries. A prompt to the generative model 322 may list the available specialist agents and ask for the query to be converted to subqueries suitable for the specialist agents. The generative model 322 returns subqueries and an indication of which specialist agent to send which sub query to.

Some example subqueries are generated in the following way. The original query is parsed to understand its structure and semantics. The main topic, subtopics and relationships between different components of the query are identified. Keywords, phrases and entities (such as specific technologies, processes, or terminologies) are extracted to understand what information is being sought. Based on this analysis, the original question is segmented into smaller parts with each part focusing on a specific aspect. Each segment is transformed into a subquery, which targets a particular piece of information needed to provide a response to the original query. Splitting a query into subqueries means that each component of the query may be handled effectively. Subqueries also allow the retrieval system to fetch precise information related to each subquery which improves the relevance and accuracy of retrieved data. Smaller subqueries are easier for a retrieval system and a language model to handle and process. Furthermore, noise and irrelevant information is reduced compared to processing a broad query without dividing into subqueries.

In an example, a query is “How can I extend the existing OrderModule on out IBM AS/400 system to integrate with moder web services”, where OrderModule is a module written in Cobol. In this example, the following subqueries may be generated from the query and sent to the following specialized agents: “what are the best practices for modifying and extending Cobol programs, specifically the OrderModule, to prepare for integration with web services?” sent to a Cobol programming expert agent; “What are the capabilities and limitations of the IBM AS/400 system regarding Cobol program execution and web service integration?” sent to an IBM AS/400 systems specialist agent; “What methods are available to integrate legacy Cobol applications with modern web services, and which protocols (REST, SOAP) are most suitable?” sent to a web services integration expert agent; “How can data be transformed between EBCDIC used by AS/400 systems and the ASCII/UTF-8 formats used in web services?” sent to a data integration agent; “What security measures should be implemented to protect data during integration, and how can we ensure compliance with relevant regulations?” sent to a security and compliance expert agent; and “What testing strategies should be employed to validate the functionality and reliability of the integrated system?” sent to a testing and quality assurance agent.

Each subquery is dispatched to an agent of a plurality of specialized agents. Four agents 326 are shown in FIG. 3 (326A-326D). As depicted in FIG. 3 by arrows to each agent 326A-D, four subqueries are dispatched. Each agent 326A-D produces output corresponding to the received subquery. Specialized agent such as agent 326A-D retrieves information from knowledge graph 328. Information is received from knowledge graph 328 in a manner such as that described with reference to FIG. 2 above as represented by arrows in FIG. 3. With the retrieved information each agent generates output corresponding to the subquery using generative model 322 which is an example of generative model 122. The agent computes a prompt based on information retrieved from the knowledge graph, by the specialist agent, and the subquery. In various examples, the prompt comprises a question combined with the retrieved information. The retrieved information could be documents or portions of source code for example. Generative model 322 produces a response to the prompt which is returned to the specialized agent. In various examples, the generative model is large language model LLM such as a model based on BERT or GPT. The generative model in some examples is fine tuned for domain-specific language relevant to software applications thus improving performance of the generative model. Each specialized agent 326A-D produces output and the output from all of the agents is combined together in order to generate a query response. In an example, there is one specialized agent that is able to take legacy source code written in a specific language such as FORTRAN or COBOL as input. Another one of the specialized agents may be dedicated to taking logs of software patch updates as input. Another one of the specialized agents may be dedicated to taking logs of security incidents experienced by the software, and others may be expert agents in one or more of: web services integration, data integration, security, compliance, testing, quality assurance. By using a plurality of specialized agents it is possible to improve efficiency since the specialized agents are able to operate in parallel. By using a plurality of specialized agents robustness is improved since if one of the agents is unavailable due to maintenance or failure, others of the agents are available. By using specialized agents performance accuracy is improved since each specialized agent may have a bespoke way of obtaining data from the knowledge graph to include in the prompt it computes.

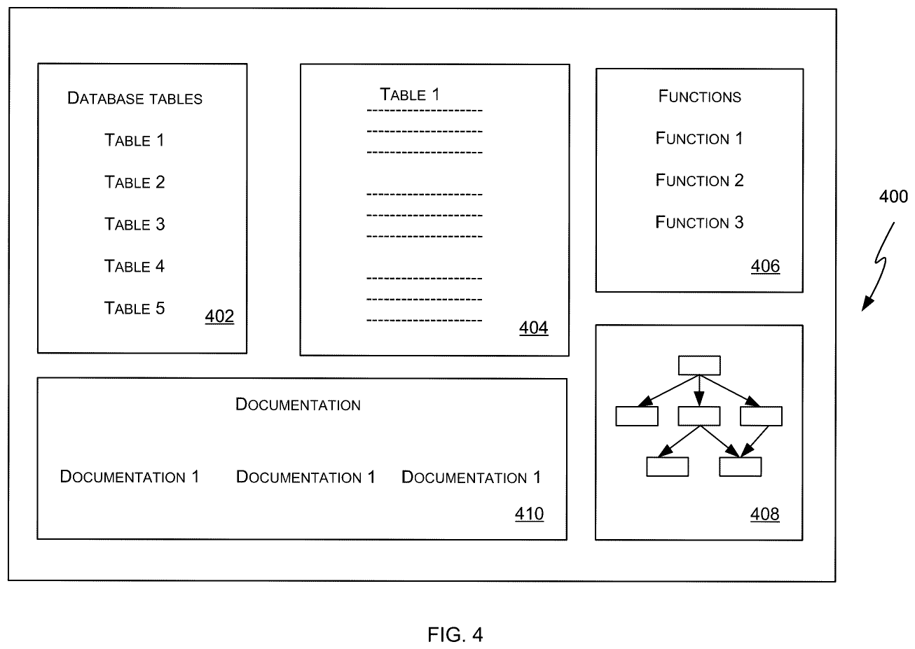

FIG. 4 shows an example explorer user interface. The explorer user interface provides a mechanism by which a human user is able to explore the legacy software application. The explorer user interface triggers queries to the knowledge graph “behind the scenes” and provides an intuitive way for the human user to interact with the knowledge graph and so manage the software application. An example graphical user interface 400 of the explorer module includes multiple panels 402-412. The explorer module may display information relating to artifacts, interdependencies, architecture, functionality, runtime behavior and usage patterns. A user interface facilitates filtering and navigating through application artifacts. Various aspects of application artifacts may be displayed such as data flows, application functions, usage, and performance.

In an example, dependencies between functions are identified and displayed. The user interface presents a call graph showing which functions call other functions. In further scenarios, statements and database tables used within the functions are displayed as information relating to performance metrics (e.g. execution time), resource utilization and error messages. Additionally or alternatively, the explorer module identifies and displays information about how different elements of the application interact. For example, if a user starts with a specific database table, the tool can trace and display the different ways that table is accessed and used throughout the application. The user may view the purpose of the table, fields, indices and views as well as other relevant information.

The explorer module enables users to navigate through automatically generated documentation as well as the software application's system architecture, components, and interdependencies. Interactive diagrams are provided which allow the user to investigate specific modules, view code snippets and understand data flows. The user may also explore code functionalities, database interactions, and runtime behaviors.

In an example scenario, the user is presented with a list of database tables from the software application. The user requires information about a specific database table and provides input via the explorer's graphical user interface. For example, the user clicks on an icon in the user interface representing the specific database table. In response, a menu is displayed to the user listing the types of further information which may be provided related to the database table. The user provides input indicating that they wish to view the different ways that the table is accessed and used throughout the software application, thus providing a query via the user interface. In other words, the query in this scenario may be to find the ways that the database is accessed and used. A response to the query is generated in the manner described above using a knowledge graph such as 128, 328 a plurality of specialized agents such as 126, 326A-D and a generative model such as 122, 322. The query response is returned to the explorer module which displays the query response in the user interface.

FIG. 4 shows an example explorer user interface for a page 400 of the explorer user interface of an explorer module such as 110. At panel 402 a list of database tables is presented. The user may select one of the database tables by clicking on a database table or by other means. In the scenario depicted in FIG. 4, the user has selected table 1 because the user wishes to find more detail about table 1. The more detail is displayed at panel 404 after having been retrieved using the process of FIG. 3. In a scenario, the user has selected table 1 and further selected to view ways that the database is accessed and used. Ways that the database is accessed and used is displayed at panel 404. For example, the database is used within functions in the software application and panel 404 displays the functions which use the database table. Additionally or alternatively, panel 404 displays snippets or portions of code from the function which reference the database table. Information displayed at 404 comprises a query response generated in response to a query. In example page 400, a list of functions of the software application is also displayed at panel 406. In various scenarios the list of functions comprises all or some of the functions of the software application which have been obtained using the process of FIG. 3 in some examples. For example, the list of functions is a list of functions which reference database table 1. The user may drill down into one of the functions by interacting with the list of functions at 406 for example by clicking on a function. At 408, a call graph is displayed which contains information about function dependencies, where the call graph has been computed using the process of FIG. 3. The functions in function graph at 408 may be the same functions displayed at 406 as well as other functions. At panel 410 in the example user interface page 400, documentation is displayed that has been computed using the process of FIG. 3. The documentation relates to the software application and may be automatically generated as described in more detail below.

Some examples of panels 402, 404, 406, 408, 410 are described with reference to FIG. 4. It is to be understood that many other panels or elements of an explorer user interface are possible. Further example panels or elements of the explorer user interface include but are not limited to: artifacts, interdependencies, architecture, functionalities, usage patterns, runtime behavior, data flows, execution time, error messages, resource utilization, performance metrics, documentation.

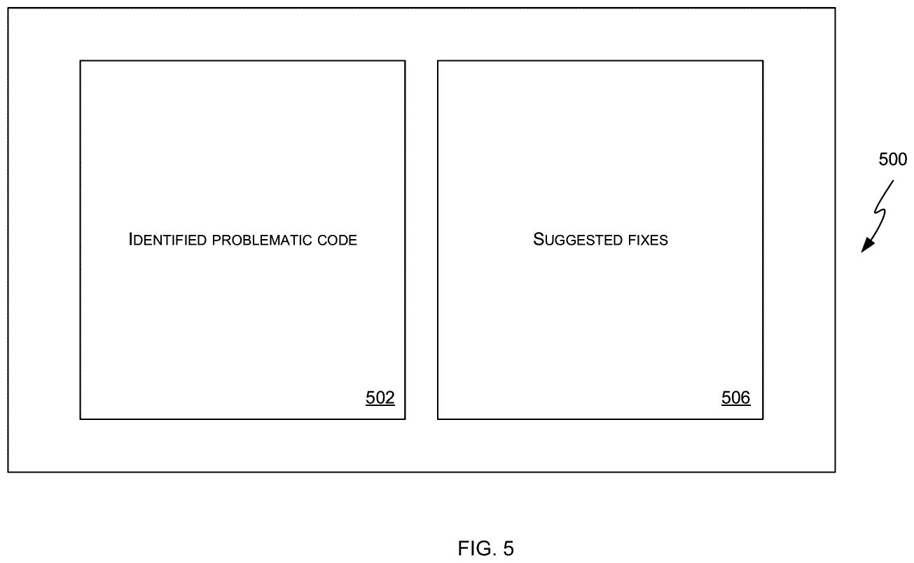

FIG. 5 shows an example advisor module interface. An advisor module such as advisor 112 identifies problematic code in the software application as well as suggested fixes for the problematic code using the method of FIG. 3 for example. In page 500 of the advisor module interface, identified problematic code is displayed at panel 502 and suggested fixes or improvements are displayed at panel 504. Examples of problems with code include but are not limited to: technical debt, anomalies, errors, bugs, outdated code practices, inefficiencies, non-compliant code structures, security vulnerabilities. The advisor module may generate a query for which a response is generated for example using the methods described with reference to FIGS. 1, 2, and 3. An example query generated by the advisor module is a query to identify a security vulnerability within the software application. Additionally or alternatively the query to identify another problem with the source code is generated by the advisor module. A query response generated in response to such a query is displayed for example at panel 502. Another query may be generated by the explorer module requesting an update recommendation which would fix the identified security vulnerability. The update recommendation may be a code improvement, or a portion of source code. The response to a query requesting an update recommendation may be displayed for example at panel 504. In various scenarios, the update recommendation comprises a change to the software application which is automatically applied to update the software application.

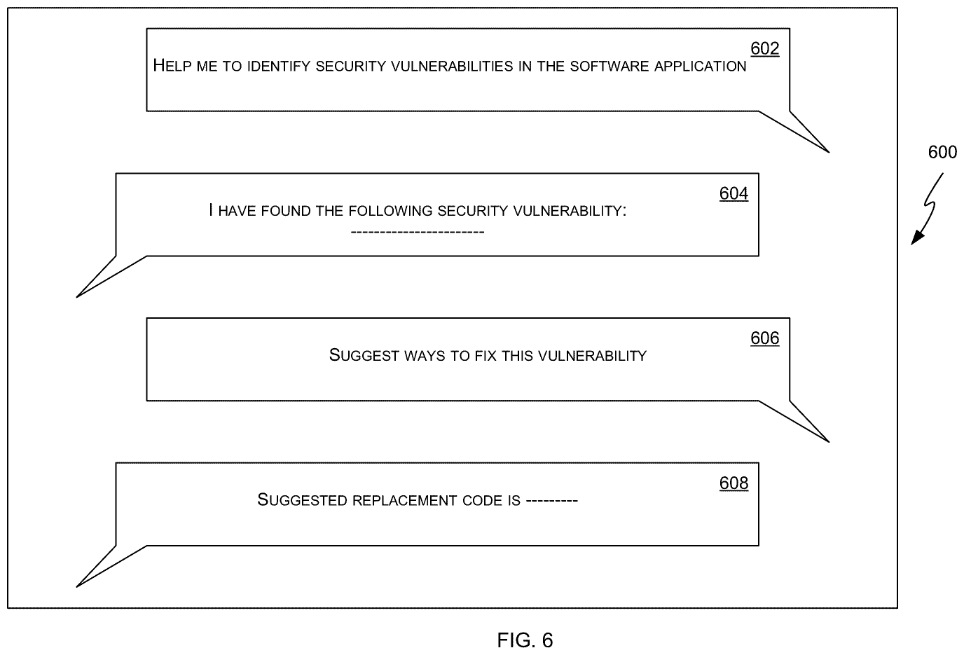

FIG. 6 shows an example chatbot interface. An example page of the chatbot interface 600 shown in FIG. 6 includes natural language input from a user at 602 and 606. At 602, the user provides natural language input to the chatbot interface requesting security vulnerabilities to be identified in the software application. This is a query received from the user via the chatbot interface. A response to the example query provided at 602 is generated for example using the methods described above with reference to FIGS. 1, 2 and 3. In this example, the query response is an identified security vulnerability such as a portion of source code with a security vulnerability. The query response is displayed at 604. The chatbot interface provides information about the security vulnerability for example reproducing a portion of source code with a security vulnerability. At 606 the user provides another query requesting ways to fix the vulnerability. A response to this query is generated and displayed by 608. The query response is for example an improved portion of source code which updates and improves the software application by fixing the identified security vulnerability. In further examples, the user may input text to the chat bot such as “What are the top 5 functions which produced the most database errors?”. Further examples of input from a user include requests for information about artifacts stored in the knowledge graph, behaviors of code, behaviors of databases, how a function is implemented, or details about past incidents related to the software application. In response to the user input, query response is generated and presented to the user. In various examples, the user may provide input to the chatbot interface comprising instructions to update the software application in order to improve the software application. The chatbot module provides broad querying capability, making the software application easier, faster and more efficient to manage, maintain and improve.

In various examples, the chatbot such as chatbot 114, 600 retains context from previous interactions with the user. This means that interaction between the user and the chatbot is improved by being more user friendly and efficient as the user is not required to re-enter information. In various examples the query processed using a knowledge base including a knowledge graph is generated using natural language input from a user. In some scenarios, the processed query includes natural language input from a user combined with input previously provided by the user. In further examples, additionally or alternatively the chatbot module proactively and automatically generates targeted questions to users. For example, knowledge base 104 may include ambiguities or missing information. Ambiguities or missing information may be identified by the chatbot module. In response the chatbot generates targeted questions to users in various scenarios. User responses to the targeted questions received at the chatbot can be used to resolve ambiguities or missing information in the knowledge base, which improves query processing because more accurate query responses can be generated.

In some scenarios, a query response comprises application documentation relating to the software application. Documentation may include explanations of code functionalities, data models, system architectures, and operational procedures. Sometimes, human-generated application documentation is poor quality because developers lack time and resources to improve documentation. Poor quality documentation results in inefficiencies, errors and security problems with the software application. Where a query response comprises application documentation, the resulting documentation leverages the information stored in the knowledge base such as knowledge base 104 and therefore the documentation quality is improved. Automatically generating documentation also saves developer time. In various scenarios, documentation is generated using a template, for example a template which aligns with organization standards. This means that the generated documentation is consistent with other documentation, and that using the documentation is easier for the user. Documentation may also be generated in a choice of format. For example the user provides input identifying a desired format of the generated documentation. The format may be HTML, PDF, or Markdown. An example generated documentation includes one or more of: a description of a module, a class diagram, a sequence diagram, a function description, security considerations.

A query response comprising application documentation may be generated in response to a query from a user such as “generate documentation relating to module 1”, or “update the documentation for module 1 including changes made since 1^{st} January”. Such a query may be entered into a chatbot interface such as described with reference to FIG. 6. Additionally or alternatively the query may be received via a user interface of an advisor module such as in FIG. 4. For example, the user may view details of a module in the explorer interface and make a selection requesting documentation to be generated relating to the module.

Some example scenarios include continuous automatic updates to documentation. In these scenarios, a query response is used to update application documentation following a change in the software application. The change in the software application is for example a modification to source code. The query relates to the change in the software application, for example the query comprises the change in the software application and optionally context around the change in the application.

In further example scenarios, the query response may comprise a test for the software application. For example, the query response is a portion of code which runs one or more tests on the software application. A test as a query response may be generated in response to a query such as “Please generate unit tests for the web-service integration of the OrderModule, including scenarios for both successful order placements and failure cases”. Using a generative machine learning model to generate tests means that potential edge cases and scenarios may be identified. Based on comments and documentation from the software application, a query response may be generated using the intended functionality of the software application. Improved testing results in more efficient, accurate and secure software applications.

In order to improve security and privacy, data may be processed and stored within a secure environment. This means that information which may be sensitive information is prevented from be transmitted externally from the secure environment. Additionally or alternatively, edge AI techniques and federated learning techniques are used to process data locally. Role-based access control may be used to manage permissions and allow access to functionalities or data to authorized personnel. Methods may also include use of data encryption and audit trails.

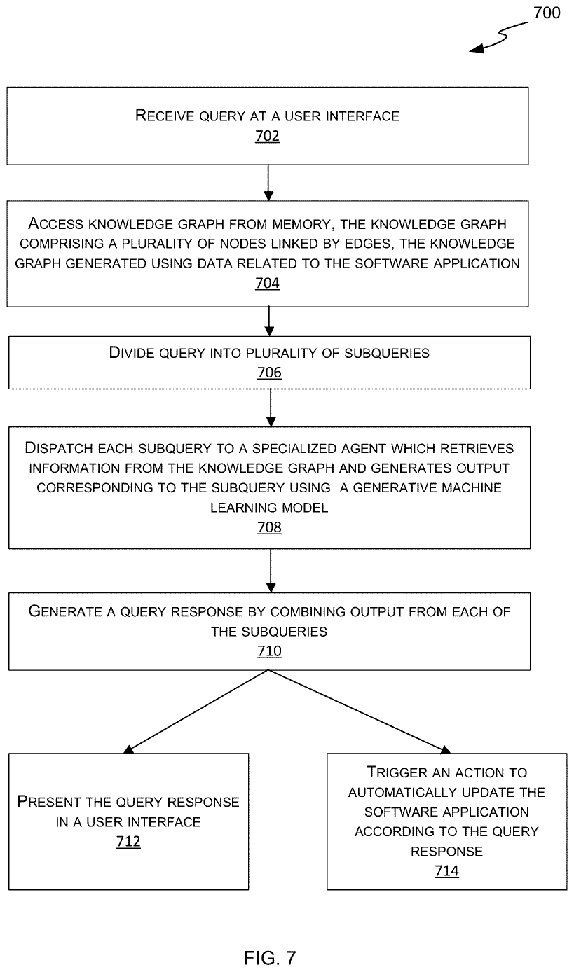

FIG. 7 is a flow diagram of a method 700 for responding to a query about a software application. At block 702, a query is received at a user interface. At block 704, a knowledge graph such as 128, 200 is accessed. The knowledge graph comprises a plurality of nodes such as 202 linked by edges such as 204 and the knowledge graph generated using data related to the software application. Example data related to the software application is described above with reference to FIG. 1. At block 706, the query such as query 302 is divided into a plurality of subqueries such as 304. At block 708, each subquery is dispatched to a specialized agent such as 326A-D, which retrieves information from the knowledge graph and generates output corresponding to the subquery using a generative machine learning model such as 322, 122. At block 710, a query response is generated by combining output from each of the subqueries. Once the query response has been generated, either the response is presented at a user interface as shown at block 712, or an action is triggered to automatically update the software application according to the query response as shown at block 714.

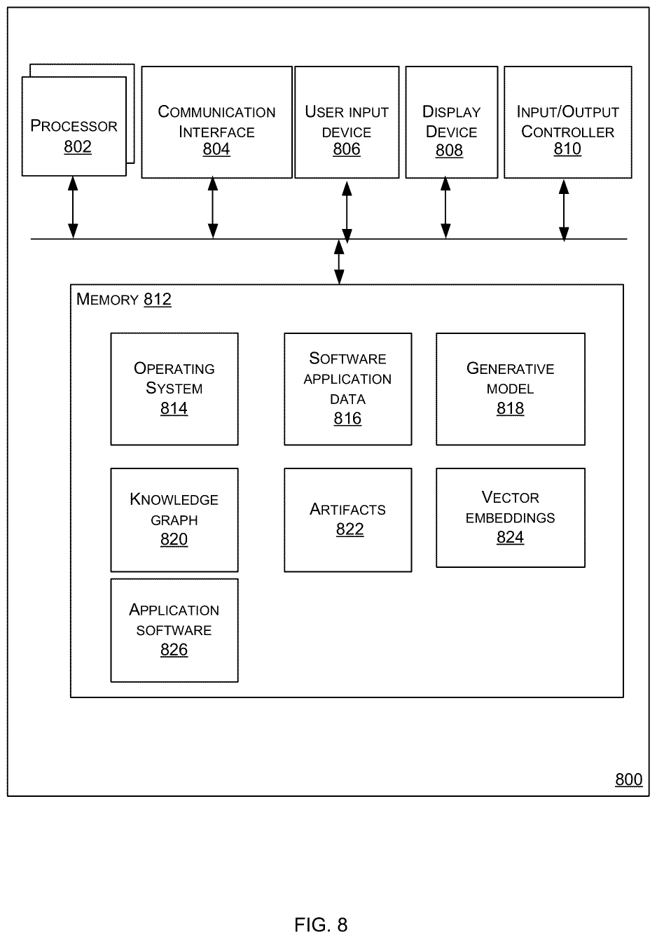

FIG. 8 illustrates various components of an exemplary computing-based device 800 which are implemented as any form of a computing and/or electronic device, and in which any of the methods described above are implemented in some examples.

Computing-based device 800 comprises one or more processors 802 which are microprocessors, controllers or any other suitable type of processors for processing computer executable instructions to control the operation of the device in order to respond to a query about a software application. In some examples, for example where a system on a chip architecture is used, the processors 802 include one or more fixed function blocks (also referred to as accelerators) which implement a part of the method of responding to a query about a software application in hardware (rather than software or firmware). Platform software comprising an operating system 814 or any other suitable platform software is provided at the computing-based device to enable application software 826 to be executed on the device. In various examples, software application data 816 is stored in memory 812. Example software application data is described above with reference to FIG. 1. In further examples, also stored in memory 812 is a generative model 818 such as model 122, 322, software artifacts 822 such as artifacts 118, a knowledge graph 820 such as 128, 200 and vector embeddings 824 such as embeddings 130.

The computer executable instructions are provided using any computer-readable media that is accessible by computing based device 800. Computer-readable media includes, for example, computer storage media such as memory 812 and communications media. Computer storage media, such as memory 812, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 812) is shown within the computing-based device 800 it will be appreciated that the storage is, in some examples, distributed or located remotely and accessed via a network or other communication link (e.g. using communication interface 804).

The computing-based device 800 also comprises an input/output controller 801 arranged to output display information to a display device 808 which may be separate from or integral to the computing-based device 800. The display information may provide a graphical user interface. The input/output controller 810 is also arranged to receive and process input from one or more devices, such as a user input device 806 (e.g. a mouse, keyboard, camera, microphone or other sensor). In some examples the user input device 806 detects voice input, user gestures or other user actions. This user input may be used to receive a query at a user interface. In an embodiment the display device 808 also acts as the user input device 806 if it is a touch sensitive display device. The input/output controller 810 outputs data to devices other than the display device in some examples, e.g. a locally connected printing device (not shown in FIG. 8).

Alternatively or in addition to the other examples described herein, examples include any combination of the following:

Clause A. A computer-implemented method for responding to a query about a software application, the method comprising:
receiving, at a user interface, the query;
accessing a knowledge graph from memory, the knowledge graph comprising a plurality of nodes linked by edges, the knowledge graph generated using data related to the software application, wherein each node stores data related to an artifact of the software application and wherein each edge represents a relationship between artifacts of the software application;
dividing, using a processor, the query into a plurality of subqueries;
for each subquery, dispatching the subquery to an agent of a plurality of specialized agents to retrieve information from the knowledge graph and generate output corresponding to the subquery using a generative machine learning model, wherein the plurality of specialized agents comprises at least one of an agent specialized in a programming language, an agent specialized in a database system, and an agent specialized in security analysis;
generating, using the processor, a query response by combining output for each of the subqueries; and
in response to the query response being generated, either presenting the query response in a user interface or triggering an action to automatically update the software application according to the query response.

Clause B. The method of clause A wherein the query is received from a user via a chatbot interface and wherein the query response is displayed to the user at the chatbot interface.

Clause C. The method of clause A wherein the query is received via an interactive graphical user interface which displays components of the software application.

Clause D. The method of clause A wherein the query is generated by an advisor module and wherein the response is an update recommendation for the software application.

Clause E. The method of any preceding clause wherein each node stores a vector embedding of the artifact stored at the node.

Clause F. The method of any preceding clause wherein the knowledge graph is the only accessed knowledge graph.

Clause G. The method of clause E or F wherein the information is retrieved from the knowledge graph using a vector search in vector space and by travelling along edges of the graph to find neighboring nodes of a starting node.

Clause H. The method of clause G wherein the vector search is used to identify a node in the knowledge graph based on distance between a vector embedding of an artifact associated with the node and a vector embedding of the query or a subquery.

Clause I. The method of clause G or H wherein the starting node is found using the vector search.

Clause J. The method of clause G, H or I wherein the vector search returns several nodes which are returned in the response together with graph neighbors of all the nodes found by the vector search.

Clause K. The method of any preceding clause wherein the query response comprises a code modification comprising one or more of: a database access logic change; a change to configurability of the software application; an additional function of the software application, an error correction; a performance improvement; a security update; a technology integration; an operational improvement; a technical debt reduction; a testing enhancement.

Clause L. The method of any of clause A-J wherein the query response comprises application documentation relating to the software application.

Clause M. The method of any of clause A-J wherein the query relates to a change in the software application, and wherein the query response is used to update application documentation following the change in the software application.

Clause N. A computer system for responding to a query about a software application, the system comprising:
a graph-based knowledge base comprising a knowledge graph generated using data related to the software application and comprising a plurality of nodes linked by edges wherein each node stores data related to an artifact of the software application and wherein each edge represents a relationship between artifacts of the software application; and
an agentic retrieval-augmented generation system comprising a large language model LLM and one or more artificial intelligence AI agents, wherein the agentic retrieval-augmented generation system:
   divides the query into one or more subqueries and dispatches each subquery to a specialized agent which retrieves information from the knowledge base and generates output corresponding to the subquery using the LLM, wherein the specialized agent is an agent specialized in a programming language, an agent specialized in a database system, or an agent specialized in security analysis; and
   generates a query response by combining output from each specialized agent.

Clause O. The computer system of clause N further comprising one of:
a chatbot interface wherein the query is received from the user via a chatbot interface and wherein the query response is displayed to the user at the chatbot interface;
an explorer module comprising a graphical user interface which displays components of the complex application a graph-based knowledge base;
an advisor module wherein the query is generated by the advisor module and the query response is an update recommendation for the complex application.

Clause P. The computer system of clause N or O wherein the one or more AI agents is a manager agent which divides the query into the one or more subqueries and determines which specialized agent to send each subquery to.

Clause Q. The computer system of clause N, O or P wherein the query response is an update to the software application and wherein the update is automatically applied to the software application.

Clause R. An apparatus comprising:
a processor; and
a memory storing instructions that, when executed by the processor, cause the processor to:
receive, at a user interface, the query;
access a knowledge graph from memory, the knowledge graph comprising a plurality of nodes linked by edges, the knowledge graph generated using data related to the software application, wherein each node stores data related to an artifact of the software application and wherein each edge represents a relationship between artifacts of the software application;
divide the query into a plurality of subqueries;
   for each subquery, dispatch the subquery to an agent of a plurality of specialized agents to retrieve information from the knowledge graph and generate output corresponding to the subquery using a generative machine learning model, wherein the plurality of specialized agents comprises at least one of an agent specialized in a programming language, an agent specialized in a database system, and an agent specialized in security analysis;
generate a query response by combining output for each of the subqueries; and
in response to the query response being generated, either present the query response in a user interface or trigger an action to automatically update the software application according to the query response.

Clause S. The apparatus of clause R further comprising one of:
a chatbot module comprising a chatbot interface wherein the query is received from the user via the chatbot interface and wherein the query response is displayed to the user at the chatbot interface;
an explorer module comprising a graphical user interface which displays components of the complex application a graph-based knowledge base;
an advisor module wherein the query is generated by the advisor module and the query response is an update recommendation for the complex application.

Clause T. The apparatus of clause R or S wherein the one or more AI agents is a manager agent which divides the query into the one or more subqueries and determines which specialized agent to send each subquery to.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computer-implemented method for responding to a query about a software application, the method comprising:
receiving, at a user interface, the query;
accessing a knowledge graph from memory, the knowledge graph comprising a plurality of nodes linked by edges, the knowledge graph generated using data related to the software application, wherein each node stores data related to an artifact of the software application and wherein each edge represents a relationship between artifacts of the software application;
dividing, using a processor, the query into a plurality of subqueries;
for each subquery, dispatching the subquery to an agent of a plurality of specialized agents to retrieve information from the knowledge graph and generate output corresponding to the subquery using a generative machine learning model, wherein the plurality of specialized agents comprises at least one of an agent specialized in a programming language, an agent specialized in a database system, and an agent specialized in security analysis;
generating, using the processor, a query response by combining output for each of the subqueries; and
in response to the query response being generated, either presenting the query response in a user interface or triggering an action to automatically update the software application according to the query response.

2. The method of claim 1 wherein the query is received from a user via a chatbot interface and wherein the query response is displayed to the user at the chatbot interface.

3. The method of claim 1 wherein the query is received via an interactive graphical user interface which displays components of the software application.

4. The method of claim 1 wherein the query is generated by an advisor module and wherein the response is an update recommendation for the software application.

5. The method of claim 4 wherein each node stores a vector embedding of the artifact stored at the node.

6. The method of claim 4 wherein the knowledge graph is the only accessed knowledge graph.

7. The method of claim 5 wherein the information is retrieved from the knowledge graph using a vector search in vector space and by travelling along edges of the graph to find neighboring nodes of a starting node.

8. The method of claim 7 wherein the vector search is used to identify a node in the knowledge graph based on distance between a vector embedding of an artifact associated with the node and a vector embedding of the query or a subquery.

9. The method of claim 7 wherein the starting node is found using the vector search.

10. The method of claim 8 wherein the vector search returns several nodes which are returned in the response together with graph neighbors of all the nodes found by the vector search.

11. The method claim 1 wherein the query response comprises a code modification comprising one or more of: a database access logic change; a change to configurability of the software application; an additional function of the software application, an error correction; a performance improvement; a security update; a technology integration; an operational improvement; a technical debt reduction; a testing enhancement.

12. The method of claim 1 wherein the query response comprises application documentation relating to the software application.

13. The method of claim 1 wherein the query relates to a change in the software application, and wherein the query response is used to update application documentation following the change in the software application.

14. A computer system for responding to a query about a software application, the system comprising:
a graph-based knowledge base comprising a knowledge graph generated using data related to the software application and comprising a plurality of nodes linked by edges wherein each node stores data related to an artifact of the software application and wherein each edge represents a relationship between artifacts of the software application; and
an agentic retrieval-augmented generation system comprising a large language model LLM and one or more artificial intelligence AI agents, wherein the agentic retrieval-augmented generation system:
divides the query into one or more subqueries and dispatches each subquery to a specialized agent which retrieves information from the knowledge base and generates output corresponding to the subquery using the LLM, wherein the specialized agent is an agent specialized in a programming language, an agent specialized in a database system, or an agent specialized in security analysis; and
generates a query response by combining output from each specialized agent.

15. The computer system of claim 14 further comprising one of:
a chatbot interface wherein the query is received from the user via a chatbot interface and wherein the query response is displayed to the user at the chatbot interface;
an explorer module comprising a graphical user interface which displays components of the complex application a graph-based knowledge base;
an advisor module wherein the query is generated by the advisor module and the query response is an update recommendation for the complex application.

16. The computer system of claim 15 wherein the one or more AI agents is a manager agent which divides the query into the one or more subqueries and determines which specialized agent to send each subquery to.

17. The computer system of claim 14 wherein the query response is an update to the software application and wherein the update is automatically applied to the software application.

18. An apparatus comprising:
a processor; and
a memory storing instructions that, when executed by the processor, cause the processor to:
receive, at a user interface, the query;
access a knowledge graph from memory, the knowledge graph comprising a plurality of nodes linked by edges, the knowledge graph generated using data related to the software application, wherein each node stores data related to an artifact of the software application and wherein each edge represents a relationship between artifacts of the software application;
divide the query into a plurality of subqueries;
for each subquery, dispatch the subquery to an agent of a plurality of specialized agents to retrieve information from the knowledge graph and generate output corresponding to the subquery using a generative machine learning model, wherein the plurality of specialized agents comprises at least one of an agent specialized in a programming language, an agent specialized in a database system, and an agent specialized in security analysis;
generate a query response by combining output for each of the subqueries; and
in response to the query response being generated, either present the query response in a user interface or trigger an action to automatically update the software application according to the query response.

19. The apparatus of claim 18 further comprising one of:
a chatbot module comprising a chatbot interface wherein the query is received from the user via the chatbot interface and wherein the query response is displayed to the user at the chatbot interface;
an explorer module comprising a graphical user interface which displays components of the complex application a graph-based knowledge base;
an advisor module wherein the query is generated by the advisor module and the query response is an update recommendation for the complex application.

20. The apparatus of claim 18 wherein the one or more AI agents is a manager agent which divides the query into the one or more subqueries and determines which specialized agent to send each subquery to.
